(19) United States
(12) Patent Application Publication
(10) Pub. No.: US 2009/0118850 A1
(43) Pub. Date: May 7, 2009

(54) Transportation control method and transportation control system

(75) Inventors: Takahiro Nakagawa, Kanagawa (JP); Takeo Tsukuda, Kanagawa (JP); Ryosuke Mori, Kanagawa (JP); Youchi Nonaka, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B. V., Amsterdam (NL)

(21) Appl. No.: 12/287,220

(22) Filed: Oct. 6, 2008

(30) Foreign Application Priority Data
Oct. 4, 2007 (JP) 2007-261138

(51) Int. Cl. G06F 19/00

(52) U.S. Cl. 700/96; 700/112

(57) ABSTRACT

Embodiments of the present invention provide a workpiece transportation control method and system that automatically processes a plurality of steps in a successive manner, thereby enhancing production efficiency. According to one embodiment, a transportation control method includes the steps of: monitoring the state of an automated manufacturing system to see if there is a request for transporting a workpiece; extracting the subsequent step path for the workpiece when a transportation request is issued; calculating a standard necessary period along the extracted step path; converting the subsequent standard necessary period into an evaluation value, issuing a transportation request, stacking tasks in response to other transportation requests; and selecting a workpiece with the shortest subsequent standard necessary period from the stacked transportation requests.

### CROSS-REFERENCE TO RELATED APPLICATION

The instant nonprovisional patent application claims priority to Japanese Patent Application No. 2007-261138 filed Oct. 4, 2007 and which is incorporated by reference in its entirety herein for all purposes.

### BACKGROUND OF THE INVENTION

In the course of manufacturing leading-edge devices, such as a semiconductor element, a magnetic storage device, a liquid crystal display, a plasma display, and a printed board, workers cannot directly carry out chemical-reaction-related processes, micromachining, microfabrication, and other processes in some cases, which may instead be carried out in an automated manufacturing system involving, for example, robots and machine devices. Further, the manufacturing system may involve several tens to several hundreds of steps, with semi-finished products (workpieces) tested in between steps.

For example, in manufacturing a magnetic storage device, a plurality of magnetic heads and magnetic discs along with other parts, such as a spindle motor and a frame, are assembled, and the resultant magnetic storage device is tested for magnetic characteristics and storage capacity in a plurality of successive automated steps. In this manner the product is completed.

In the case of a printed board, microelectronics parts, such as semiconductor chips and capacitors, are mounted on a printed substrate by using an automated tool, and automatically bonded in a solder reflow furnace. The resultant printed board is tested for electric performance in an automated tool.

In such product manufacturing processes, increasing the productivity of the automated manufacturing system is an important issue from the viewpoint of investment recovery. Provided that improvement in productivity is defined as the production yield per unit time, net working period and associated working period must be reduced to improve the productivity. In an automated manufacturing system, in particular, it is important not only to lower occurrence of failure of the system but also to reduce the associated working period, for example, setup working period in preparation for net working operation and waiting period in which workpieces do not flow until steps are ready to accept the workpieces.

For example, in manufacturing magnetic storage devices, all magnetic storage devices may be tested for their magnetic characteristics and storage capacity in a plurality of successive automated steps. A conventional example of such a test is a batch operation method in which several tens to several hundreds of magnetic storage devices are collectively placed and tested (as a batch) in a testing device and the batch is tested again in another testing device in the following step. In this process, the following problems may arise: (1) a magnetic storage device characteristics problem—magnetic storage devices having the same storage capacity but different individual read/write performance require different-length test periods, and (2) an operation-related problem—magnetic storage devices cannot be removed from a testing device unless at least a defined number of magnetic storage devices among the total number thereof pass a test. Such problems increase the associated working period. That is, in a batch operation, the problems (1) and (2) described above cause a magnetic storage device that has already been tested to stay in a testing device until the tests of the other magnetic storage devices are completed. Such a situation increases the associated working period, and prevents improvement in productivity of the automated manufacturing system.

To solve the above problems, there is an individual operation method in which magnetic storage devices are placed and tested one-by-one in a testing device and again placed and tested one by one in another testing device in the following step. There is also an automated manufacturing system using the above method. The automated manufacturing system includes a set of several tens to several thousands of testing devices and uses a robot handler to transport magnetic storage devices one by one to the testing devices for testing. In this system, if a plurality of magnetic storage devices waiting to be transported by the robot handler are not transported in a well-ordered manner, the following problems occur: (a) a magnetic storage device that has been tested in a testing step cannot be transported to a testing device in the following step because the testing device is occupied with another magnetic storage device, and (b) even when there is an idle testing device, a magnetic storage device being tested in a testing device in the previous testing step cannot be transported. Such problems increase the associated working period, and prevent improvement in productivity of the automated manufacturing system.

Several other attempts have been made to improve productivity of an automated manufacturing system, and some of the methods for reducing associated working period will be described below. Japanese Patent Publication No 2000-280147 (“Patent Document 1”) proposes a method for issuing a robot operation command by estimating a working period and using the estimated working period as the period that will elapse from the time when a semi-finished product (workpiece) is loaded to estimate the time when the workpiece is unloaded. Japanese Patent Publication No. 6-270040 (“Patent Document 2”) proposes a method for prioritizing workpiece transportation by weighting items in an occurrence timing history for a device that has issued a request and items in occurrence timing prediction for a device that will issue a request in consideration of the working rate and processing plan of the devices. Japanese Patent Publication No. 2003-195919 (“Patent Document 3”) proposes a prioritization method in which workpieces are transported on a first-requested-first-transported basis unless there is a workpiece with a higher priority transportation request. Japanese Patent Publication No. 11-121582 (“Patent Document 4”) proposes a workpiece transportation method for estimating a remaining period required for processing a workpiece being processed in a device, estimating a period required for transporting the next workpiece from its waiting place to the device, and setting a workpiece transportation time by calculating the difference between the two periods. “Russ M, Dabbas and John W. Fowler: A new Scheduling Approach Using Combined Dispatching Criteria in Wafer Fabs”, IEEE Transactions on Semiconductor Manufacturing, Vol. 16, NO. 3, August 2003 (“Non-patent Document 1”) proposes a method for detecting the state of workpieces being processed in the entire production system in a snapshot manner and using the state to switch a workpiece transportation prioritization rule to another.

The methods described in Patent Documents 1, 2, 3, and 4 and Non-patent Document 1 described above do not provide direct solutions of the problems: for a plurality of workpieces waiting to be transported, (a) a workpiece that has gone through a step cannot be transported because another workpiece occupies the following step, and (b) even when there is an idle step, a workpiece being processed in the previous step cannot be transported.

That is, the method described in Patent Document 1 relates to the operation of a robot in a single step, but does not solve the above transportation problems (a) and (b) caused by interaction among a plurality of steps. The method described in Patent Document 2 tries to match the actual task to the target working rate and processing plan for each device, but does not solve the above transportation problems (a) and (b) caused by interaction among a plurality of steps. The method described in Patent Document 3 relates to a procedure of transporting a prioritized workpiece, but does not solve the above transportation problems (a) and (b) caused by interaction among a plurality of steps. The method described in Patent Document 4 aims to improve productivity by keeping workpieces being processed, but does not solve the above problems (a) and (b). The method described in Non-patent Document 1 relates to workpiece transportation prioritization with the aim of adjusting the throughput in each step in consideration of the delivery time of each workpiece, but does not solve the above problems (a) and (b).

Further, a production system handled by an automated manufacturing system often includes a plurality of semi-finished product testing steps. Depending on the test results, the production system further includes a reprocessing procedure in which the processes themselves are carried out again, and the production system further includes, when including an assembling task, a reloading procedure in which a workpiece is disassembled and then reassembled by replacing some of the parts with new parts. That is, a possible step path through which workpieces waiting to be transported flow includes not only a normal straight path but also the reprocessing path and the reloading path described above. Therefore, Patent Documents 1, 2, 3, and 4 and Non-patent Document 1 described above present a problem (c): the methods described in the above documents do not allow what step paths workpieces waiting to be transported flow through to be checked, and hence the workpieces cannot be transported in a prioritized manner in consideration of the subsequent step paths.

### BRIEF SUMMARY OF THE INVENTION

Embodiments of the present invention provide a workpiece transportation control method and system that automatically processes a plurality of steps in a successive manner, thereby enhancing production efficiency. According to one embodiment, a transportation control method includes the steps of: monitoring the state of an automated manufacturing system to see if there is a request for transporting a workpiece; extracting the subsequent step path for the workpiece when a transportation request is issued; calculating a standard necessary period along the extracted step path; converting the subsequent standard necessary period into an evaluation value, issuing a transportation request, stacking tasks in response to other transportation requests; and selecting a workpiece with the shortest subsequent standard necessary period from the stacked transportation requests.

### BRIEF DESCRIPTION OF THE DRAWINGS

FIG. 1 shows a procedure of implementing a transportation control method according to an embodiment of the invention;

FIG. 2 is a diagrammatic view of an automated manufacturing system to which an embodiment of the invention is applied;

FIG. 3 is a diagrammatic view of another example of the automated manufacturing system to which an embodiment of the invention is applied;

FIG. 4 is an exemplary configuration of software and hardware that achieve the transportation control method according to one embodiment;

FIG. 5 is a workpiece loading control flowchart for the automated manufacturing system in which an embodiment of the invention is implemented;

FIG. 6 is a device control flowchart for the automated manufacturing system in which an embodiment of the invention is implemented;

FIG. 7 shows an exemplary step path for manufacture in which an embodiment of the invention is implemented;

FIG. 8 shows the characteristics of the processing period for each step in the step path for manufacture in which an embodiment of the invention is implemented;

FIG. 9 shows an example of the processing period for each step in the step path for manufacture in which an embodiment of the invention is implemented;

FIG. 10 shows an example of a subsequent standard necessary period for manufacture in which an embodiment of the invention is implemented;

FIG. 11 shows the system configuration of the automated manufacturing system in which an embodiment of the invention is implemented; and

FIG. 12 shows another exemplary step path for manufacture in which an embodiment of the invention is implemented.

### DETAILED DESCRIPTION OF THE INVENTION

Embodiments of the present invention relate to manufacturing a product, such as a semiconductor element, a magnetic storage device, a liquid crystal display, a plasma display, and a printed board, by automatically processing a plurality of steps in a successive manner, and provides a method and a system for enhancing production efficiency.

Embodiments of the invention provide a workpiece transportation prioritization technology that solves the following problems: for a plurality of workpieces waiting to be transported, (c) the subsequent step paths cannot be checked, (a) a workpiece that has gone through a step cannot be transported because another workpiece occupies the following step, and (b) even when there is an idle step, a workpiece being processed in the previous step cannot be transported.

To solve one or more of the above problems, a representative transportation control method of embodiments of the invention includes the steps of: monitoring the state of an automated manufacturing system to see if there is a request for transporting a workpiece; checking the subsequent step path for the workpiece when a transportation request is issued; calculating a standard necessary period along the checked step path; converting the subsequent standard necessary period into an evaluation value, issuing a transportation request, and stacking tasks in response to other transportation requests; and selecting a workpiece with the shortest subsequent standard necessary period from the stacked transportation requests.

To solve one or more of the above problems, a representative transportation control system of embodiments of the invention includes: a first storage unit that stores a step path for a workpiece; a second storage unit that converts the subsequent standard necessary period along the step path for the workpiece into an evaluation value and stores a plurality of transportation requests; state monitoring means for monitoring the state of an automated manufacturing system to see if there is a request for transporting the workpiece, in the event of an transportation request, extracting the subsequent step path for the workpiece that has issued the transportation request from the first storage unit, calculating the subsequent standard necessary period along the extracted step path, and converting the calculated subsequent standard necessary period into an evaluation value and storing the transportation request in the second storage unit; and transportation control means for selecting a workpiece with the shortest subsequent standard necessary period from the transportation requests stored in the second storage unit.

According to embodiments of the invention, devices in an automated manufacturing system can accept workpieces by transporting a workpiece to be unloaded earlier than the others from the automated manufacturing system. For a plurality of workpieces waiting to be transported into the automated manufacturing system, the following problems can be solved: (a) a workpiece that has gone through a step cannot be transported because other workpieces occupy the devices in the following step, and (b) even when there is an idle device, a workpiece being processed in a device in the previous step cannot be transported. Therefore, the associated working period can be reduced, which contributes to increase in productivity of the automated manufacturing system.

Particular embodiments of the invention will be described below with reference to the drawings.

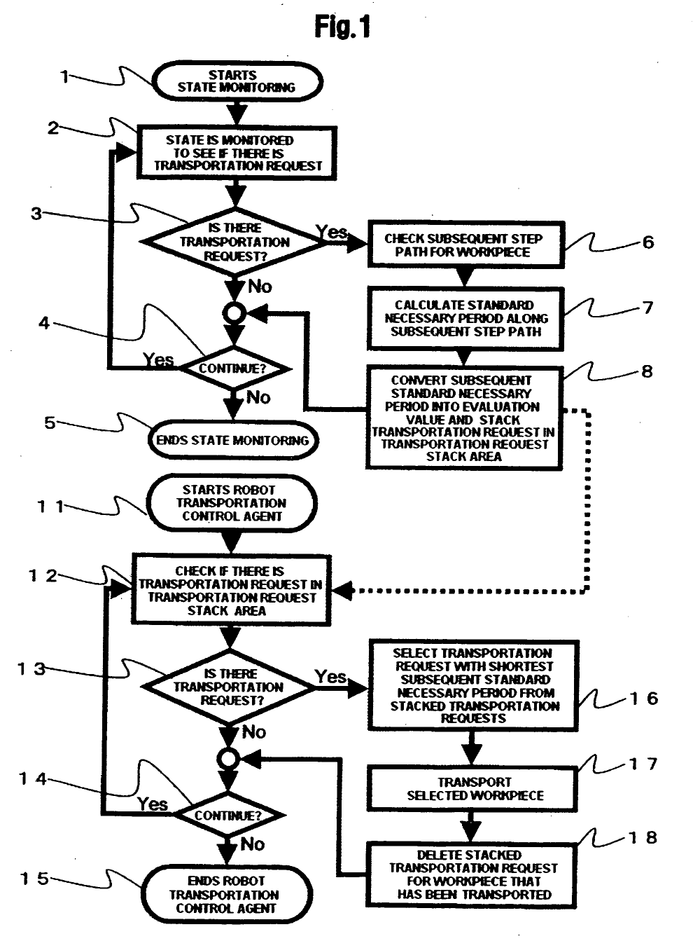

FIG. 1 shows a procedure of implementing a transportation control method according to an embodiment. The procedure is an example using a multi-agent system. A multi-agent system is a system formed of a plurality of agents that autonomously perform sensing, judging, and processing to achieve respective targets, and a system in which the action of the entire system relies on interaction among the agents. FIG. 1 describes procedures of implementing a state monitoring agent and a robot transportation control agent. First, when the state monitoring agent is started (step 1), the state of an automated manufacturing system is monitored to see if there is a transportation request in the automated manufacturing system (step 2). When a transportation request is found (step 3), the subsequent path for a workpiece that has issued the transportation request is checked (step 6), and a standard necessary period along the subsequent step path is calculated (step 7). The subsequent standard necessary period is then converted into an evaluation value, and the transportation request is stacked in a transportation request stack area (step 8). When there is no transportation request (step 3), it is checked if the state monitoring agent is intended to remain in operation (step 4). When the state monitoring agent is intended to remain in operation, the state monitoring agent continues monitoring the state to see if there is a transportation request (step 2). When the state monitoring agent is not required to remain in operation (step 4), the state monitoring agent is terminated (step 5).

The robot transportation control agent is started at the same time when the state monitoring agent is started (step 11). It is first checked if there is a transportation request in the transportation request stack area (step 12). When there is a transportation request (step 13), a transportation request with the shortest subsequent standard necessary period is selected from the stacked transportation requests (step 16), and the selected workpiece is transported (step 17). The stacked transportation request for the workpiece that has been transported is deleted (step 18). When there is no transportation request (step 13), it is checked if the robot transportation control agent is intended to remain in operation (step 14). When the robot transportation control agent is intended to remain in operation, the robot transportation control agent continues checking if there is a transportation request in the transportation request stack area (step 12). When the robot transportation control agent is not required to remain in operation (step 14), the robot transportation control agent is terminated (step 15).

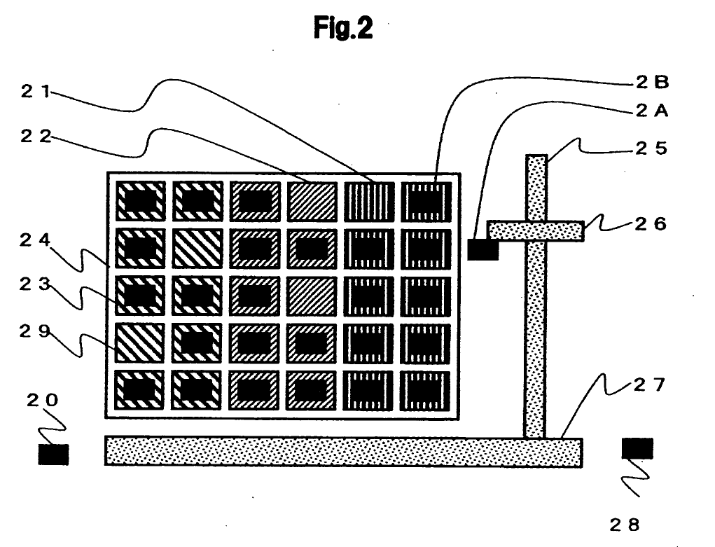

FIG. 2 is a diagrammatic view of the automated manufacturing system to which the above transportation control method is applied. In this description, the automated manufacturing system includes three successive steps: a first step formed of a plurality of devices 23 (rectangular boxes, each having a background hatched with diagonal lines running from the upper left to the lower right), a second step formed of a plurality of devices 22 (rectangular boxes, each having a background hatched with diagonal lines running from the upper right to the lower left), and a third step formed of a plurality of devices 21 (rectangular boxes, each having a background hatched with vertical lines). All the first, second, and third steps are incorporated into a single unit 24. The unit is an apparatus that manages the power supplies and temperatures of the devices 21, 22, and 23 in a collective manner. In some of the first step devices 23, a workpiece indicated by a black rectangular box is placed, and a device 29 without any workpiece placed therein indicates that the device 29 is idle. Since the total number of devices in the unit 24 is fixed, the numbers of devices allocated and used in the first, second, and third steps are adjusted in such a way that the sum of the numbers of devices that form the first, second, and third steps is equal to or smaller than the total number of devices in the unit 24. A workpiece 2B is placed in the unit 24 and processed in the devices in the first, second, and third steps. The workpiece 2B, a workpiece 20, and a workpiece 28 are loaded and unloaded by using a robot handler formed of a horizontally moving shaft 27, a vertically moving shaft 25, and an end effecter 26. The robot handler 25, 26, and 27 may have a configuration in which the vertically moving shaft 25 and the end effecter 26 form a multi-joint robot, or a configuration in which only the end effecter 26 forms a multi-joint robot. The robot handler 25, 26, and 27 picks up a workpiece 20 to be loaded in the automated manufacturing system, loads the workpiece 20 in the unit 24, and unloads the workpiece from the unit 24. The unloaded workpiece becomes a workpiece 28. The robot handler 25, 26, and 27 also transports a processed workpiece in a device 23 in the first step to a device 22 in the second step, and transports a processed workpiece in a device 22 in the second step to a device 21 in the third step.

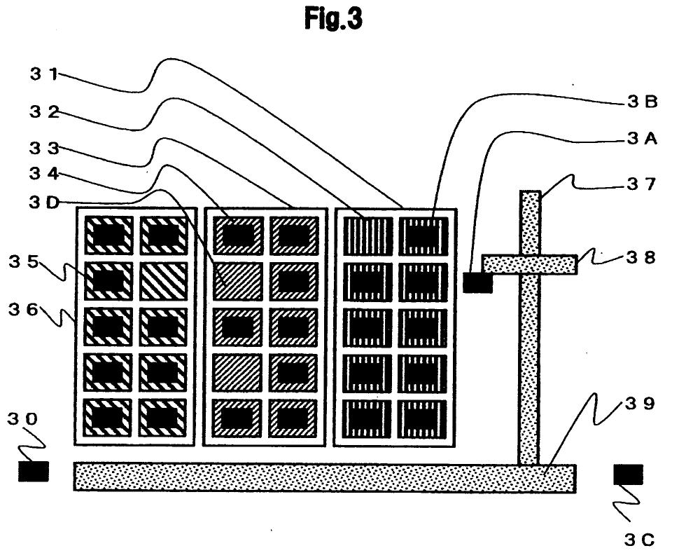

FIG. 3 is a diagrammatic view of another example of the automated manufacturing system to which the above transportation control method is applied. As in FIG. 2, the automated manufacturing system includes three successive steps: a first step formed of a plurality of devices 35 (rectangular boxes, each having a background hatched with diagonal lines running from the upper left to the lower right), a second step formed of a plurality of devices 34 (rectangular boxes, each having a background hatched with diagonal lines running from the upper right to the lower left), and a third step formed of a plurality of devices 32 (rectangular boxes, each having a background hatched with vertical lines). In some of the second step devices 34, a workpiece indicated by a black rectangular box is placed, and a device 3D without any workpiece placed therein indicates that the device 3D is idle. A robot handler 37, 38, and 39 having the same configuration as that of the robot handler 25, 26, and 27 shown in FIG. 2 is applied. The robot handler 37, 38, and 39 may have a configuration in which a vertically moving shaft 37 and an end effecter 38 form a multi-joint robot, or a configuration in which only the end effecter 38 forms a multi-joint robot. FIG. 3 differs from FIG. 2 in that there are one or more units 36 formed in the first step, one or more units 33 formed in the second step, and one or more units 31 formed in the third step, and in that the total number of devices in the automated manufacturing system is not limited but the number of devices can be freely set in the first, second, and third steps, respectively. The unit is an apparatus that manages power supplies and temperatures of the devices 35, 34, and 32 in a collective manner. The robot handler 37, 38, and 39, for example, picks up a workpiece 30 to be loaded in the automated manufacturing system, loads a workpiece 3A in a device, unloads a workpiece 3B, unloads a workpiece, like a workpiece 3C, out of the automated manufacturing system, transports a workpiece that has been processed in a device 35 in the first step to a device 3D in the second step, and transports a workpiece that has been processed in a device 34 in the second step to a device 32 in the third step.

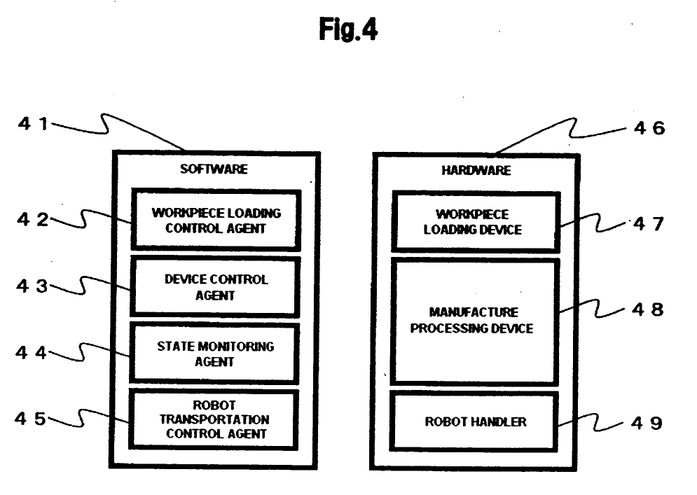

FIG. 4 is an exemplary configuration of software and hardware that form the automated manufacturing system described above. The configuration is an exemplary configuration using the multi-agent system described with reference to FIG. 1. Software 41 includes a workpiece loading control agent 42, a device control agent 43, a state monitoring agent 44, and a robot transportation control agent 45. The hardware 46 includes a workpiece loading device 47, a manufacture processing device (in-step processing device) 48, and a robot handler 49. The workpiece loading control agent 42 detects a loading completion signal from the workpiece loading device 47 and sends a process signal to the robot transportation control agent 45. The device control agent 43 sends a processing program to the manufacture processing device 48 and selects the next process according to the process completion state. The state monitoring agent 44 monitors the state to see if there is a workpiece transportation request. When there is a transportation request, the transportation request is stacked in the transportation request stack area. When there is a transportation request in the transportation request stack area, the robot transportation control agent 45 selects as appropriate the workpiece that has issued the transportation request, and activates the robot handler 49.

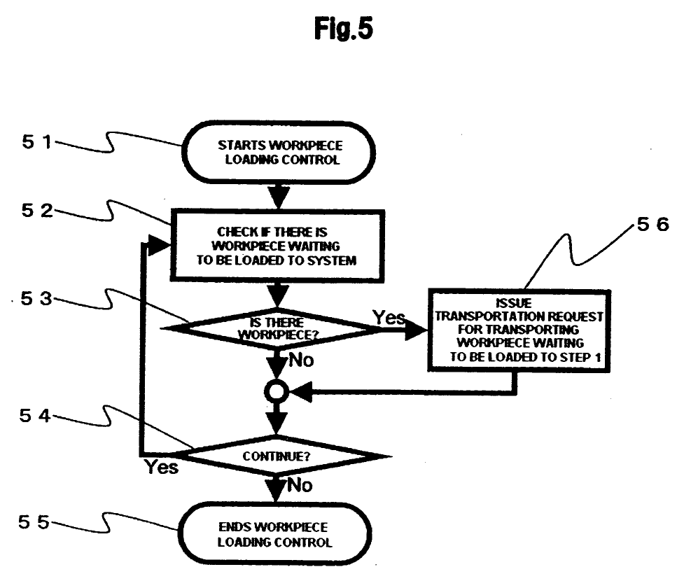

FIG. 5 is an example of workpiece loading control flowchart for the automated manufacturing system described above. The flowchart uses the multi-agent system described with reference to FIG. 1. When the workpiece loading control agent is started (step 51), it is checked if there is a workpiece waiting to be loaded to the automated manufacturing system (step 52). When there is a workpiece waiting to be loaded (step 53), a transportation request for transporting the workpiece waiting to be loaded to the step 1 (first step) is issued (step 56). When there is no workpiece waiting to be loaded (step 53), it is checked if the workpiece loading control agent is intended to remain in operation (step 54). When the workpiece loading control agent is intended to remain in operation, the workpiece loading control agent continues checking if there is a workpiece waiting to be loaded to the automated manufacturing system (step 52). When the workpiece loading control agent is not intended to remain in operation (step 54), the workpiece loading control agent is terminated (step 55).

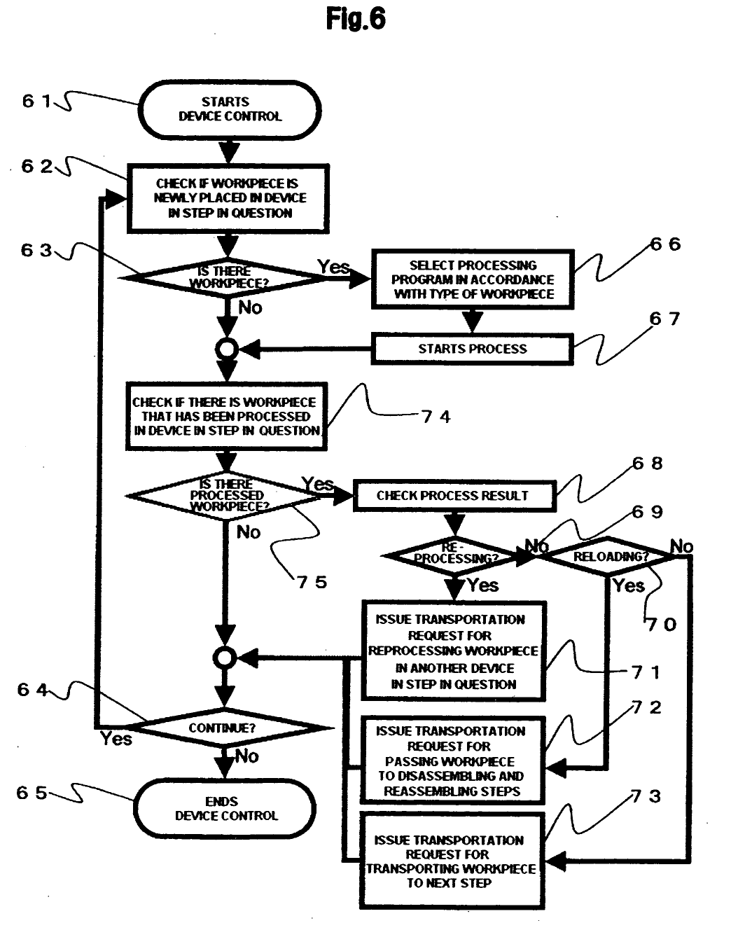

FIG. 6 is an example of a device control flowchart for the automated manufacturing system. The flowchart uses the multi-agent system described with reference to FIG. 1. When the device control agent is started (step 61), it is first checked if a workpiece is newly placed in a device in the step in question. When there is a newly placed workpiece (step 63), a processing program is selected in accordance with the type of the workpiece (step 66), and the corresponding process is executed (step 67). It is checked if there is a workpiece that has been processed in a device in the step in question (step 74). When there is a workpiece that has been processed (step 75), the process result is checked (step 68). When reprocessing is necessary (step 69), a transportation request is issued to reprocess the workpiece in another device in the step in question (step 71). When reloading is necessary (step 70), a transportation request is issued to pass the workpiece to disassembling and reassembling steps (step 72). When reloading is not necessary (step 70), a transportation request is issued to transport the workpiece to the next step (step 73). When there is no workpiece that has been processed in the devices in the step in question (step 75), it is checked if the device control agent is intended to remain in operation (step 64). When the device control agent is intended to remain in operation, the device control agent continues checking if a workpiece is newly placed in a device in the step in question (step 62). When the device control agent is not intended to remain in operation (step 64), the device control agent is terminated (step 65).

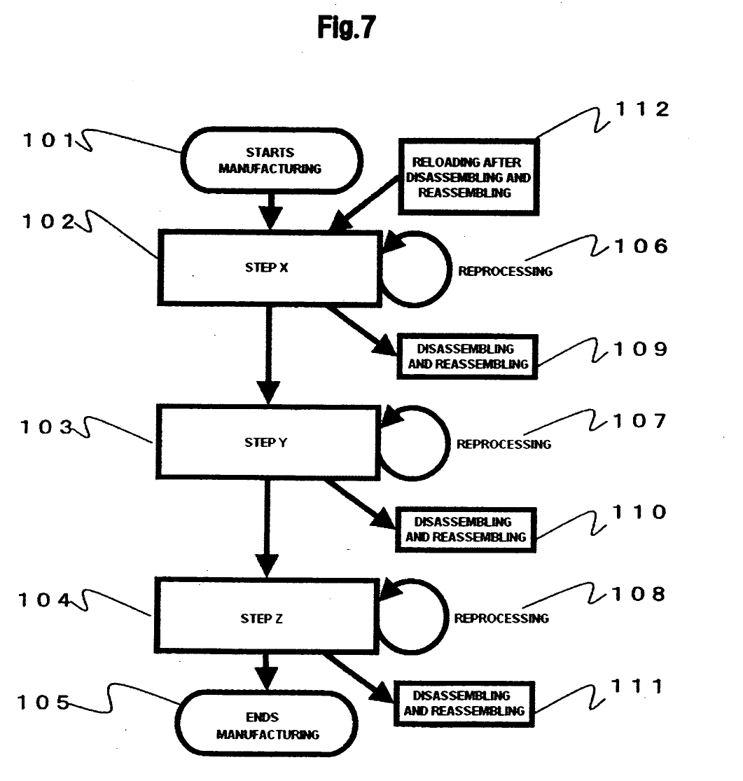

Manufacturing steps handled by the automated manufacturing system will be specifically described below. FIG. 7 is an exemplary step path for manufacture in which the transportation control method described above is carried out. The manufacture shown in the figure includes the following successive steps: a step X indicated by reference numeral 102, a step Y indicated by reference numeral 103, and a step Z indicated by reference numeral 104. The step X (102), the step Y (103), and the step Z (104) respectively include procedures 106, 107, and 108 in which, as a result of manufacture, the workpiece is reprocessed in the same step and procedures 109, 110, and 111 in which, as a result of manufacture, the workpiece is returned to disassembling and reassembling steps. The step X (102) further includes a procedure 112 in which the workpiece is reloaded after the disassembling and reassembling steps.

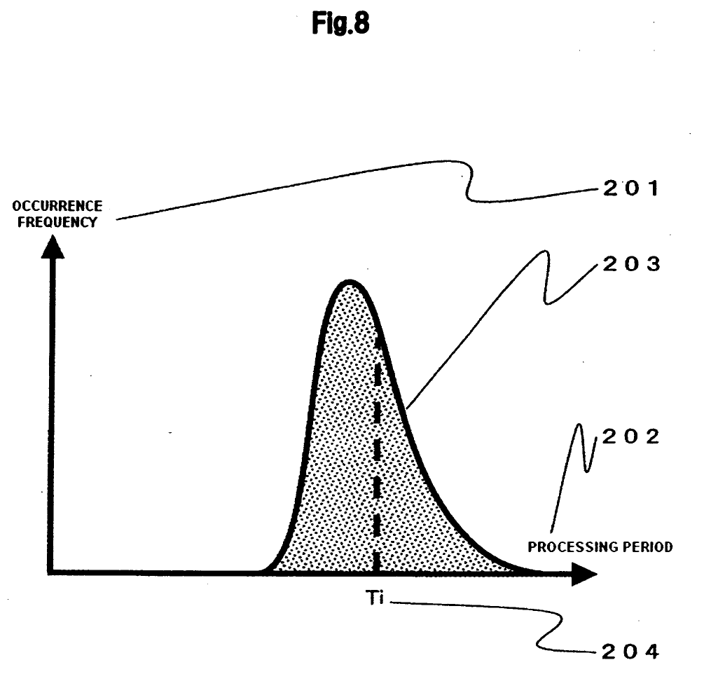

FIG. 8 shows an example of the characteristics of the processing period for each step in the above step path. In the manufacture handled in the step path shown in FIG. 7, the processing period varies in each of the steps. In FIG. 8, the horizontal axis represents the processing period 202 and the vertical axis represents process completion occurrence frequency 201. The graph in FIG. 8 represents step-dependent variation 203 in processing period. The average processing period is indicated by Ti 204 in the figure.

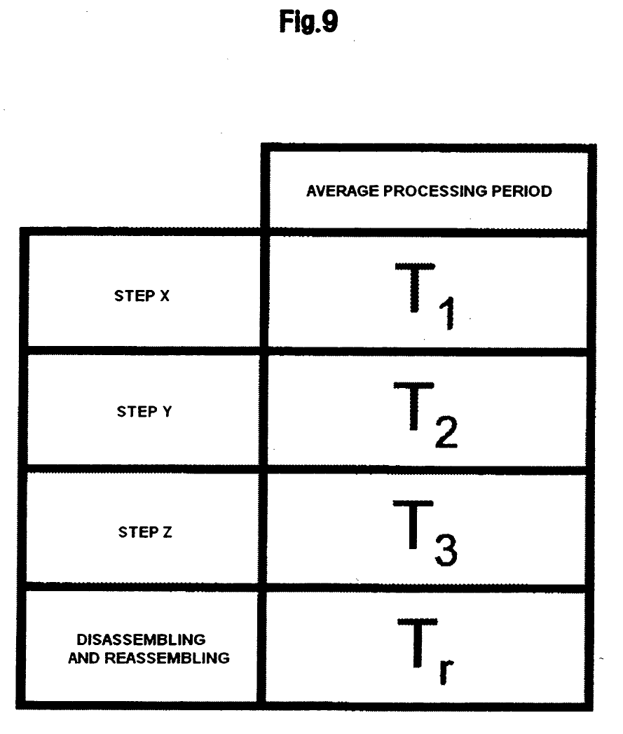

FIG. 9 shows an example of the processing period for each step in the above step path. In the step path shown in FIG. 7, the processing period varies in each of the steps, as shown in FIG. 8. In FIG. 9, the average processing period is set to T1 for the step X, T2 for the step Y, T3 for the step Z, and Tr for the disassembling and reassembling steps.

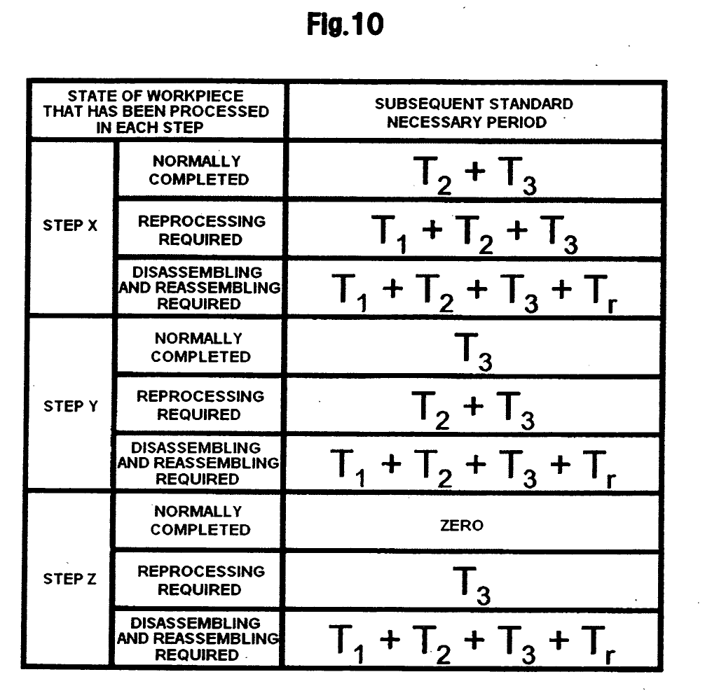

FIG. 10 shows an example of the subsequent standard necessary period in the automated manufacturing system described above. Provided that the average processing periods for the steps in the step path shown in FIG. 7 are those shown in FIG. 9, a workpiece that has been processed in each of the steps has one of the following three states: normally completed, reprocessing required, and disassembling and assembling required, as shown in FIG. 10. The subsequent standard necessary period can be calculated for each of the states for each of the steps. Each of the standard necessary periods is converted into an evaluation value to sort the stacked transportation requests. A workpiece with the shortest standard necessary period is selected and transported.

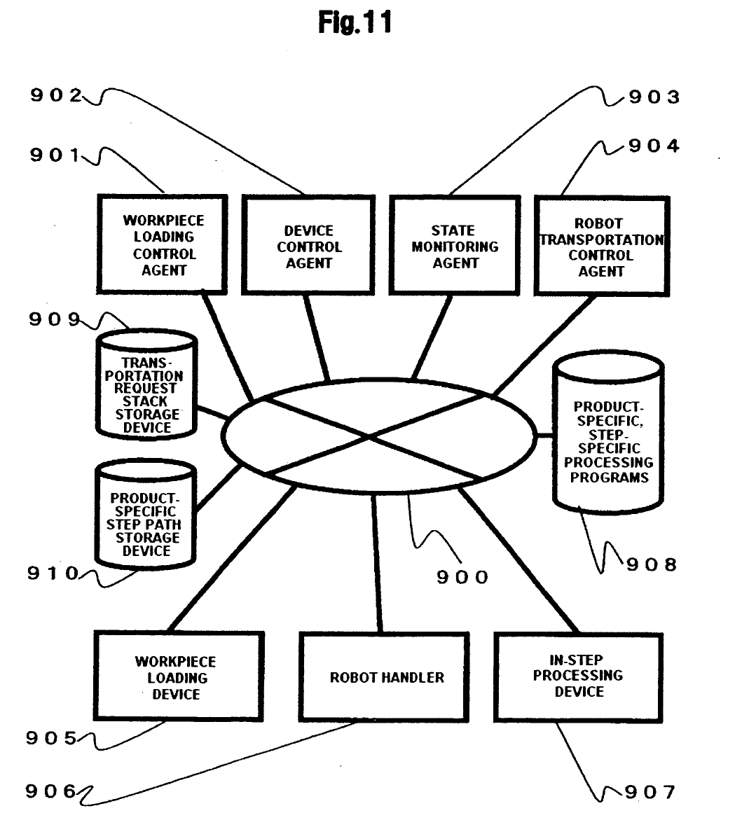

FIG. 11 shows an exemplary system configuration of an automated manufacturing system including a transportation control system that carries out the transportation control method described above. The system configuration uses the multi-agent system described with reference to FIG. 1. A network 900 as a core is connected to a workpiece loading control agent 901, a device control agent 902, a state monitoring agent (state monitoring means) 903, a robot transportation control agent (transportation control means) 904, a workpiece loading device 905, a robot handler 906, a manufacture processing device (in-step processing device) 907, product-specific, step-specific processing programs 908, a transportation request stack storage device 909, and a product-specific step path storage device 910. When a workpiece is loaded in the automated manufacturing system, the workpiece loading device 905 reads an identification number displayed on a workpiece, and selects and extracts a step path for the workpiece from the product-specific step path storage device 910. A process program is also selected and extracted from the product-specific, step-specific processing programs 908. The state monitoring agent 903 monitors the state of the automated manufacturing system to see if there is a workpiece transportation request. When there is a transportation request, the subsequent step path for the workpiece that has issued the transportation request is extracted from the product-specific step path storage device 910. The subsequent standard necessary period along the extracted step path is calculated, and the resultant standard necessary period is converted into an evaluation value. The transportation request is stored in the transportation request stack storage device 909. The robot transportation control agent 904 selects a workpiece with the shortest subsequent standard necessary period from the transportation requests stored in the transportation request stack storage device, and controls the robot handler 906 to transport the workpiece.

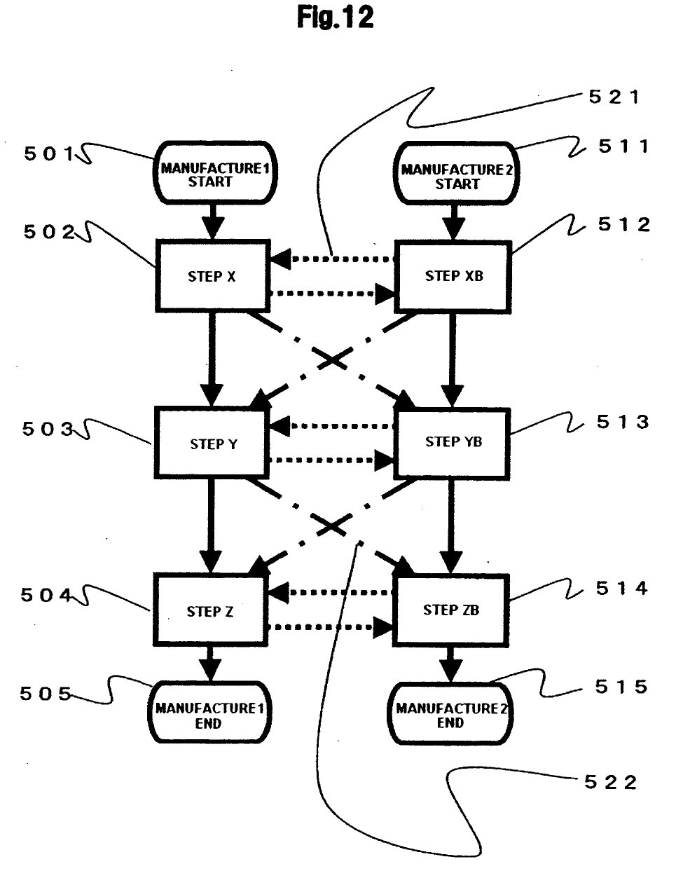

FIG. 12 is an example of improvement on the step path shown in FIG. 7. In FIG. 12, the disassembling and reassembling procedures 109, 110, 111 and the reloading procedure 112 after the disassembling and reassembling shown in FIG. 7 are omitted. As shown in FIG. 7, the step path starts with the manufacture 1 START step 501 through the step X indicated by reference numeral 502, the step Y indicated by reference numeral 503, and the step Z indicated by reference numeral 504 to the manufacture 1 END step 505. The path herein refers to as a step path 1. In FIG. 12, a step path 2 formed of the same manufacturing procedure and manufacturing devices as those in the step path 1 is also provided. That is, the step path 2 starts with the manufacture 2 START step 511 through the step XB indicated by reference numeral 512, the step YB indicated by reference numeral 513, and the step ZB indicated by reference numeral 514 to the manufacture 2 END step 515. The step XB (512) has manufacturing devices having the same specifications as those of the devices in the step X (502). Similarly, the step YB (513) has manufacturing devices having the same usage as that of the devices in the step Y (503), and the step ZB (514) has manufacturing devices having the same specification as that of the devices in the step Z (504). For the step X (502) and the step XB (512), the step Y (503) and the step YB (513), and the step Z and the step ZB (514), each of the pairs has a procedure 521 in which a workpiece is transported from one to the other (all arrows expressed by the dotted lines in the figure). Further, for the step X (502) and the step YB (513), the step XB (512) and the step Y (503), the step Y (503) and the step ZB (514), and the step YB (513) and the step Z (504), each of the pairs has a procedure 522 in which a workpiece is transported from the former to the latter (all arrows expressed by the dashed lines in the figure). The devices in each of the steps will fail at a certain rate, so that working devices in one step at an arbitrary time differ from those in the other steps. That is, when there is only the manufacturing path 1 and a workpiece that has gone through the step X (502) cannot be transported from the step X (502) to the step Y (503) because all the devices in the step Y (503) are occupied with other workpieces, the workpiece cannot be transported but must wait until any of the devices in the step Y (503) becomes idle. Such a waiting period contributes to reduction in productivity of the automated manufacturing system. However, if a device in the step YB (513) is idle, the procedure (522) in which a workpiece is transported from the step X (502) to the step YB (513) is used to transport the workpiece, which then undergoes the manufacturing process in the step YB. There is thus no waiting period described above, and hence the productivity is advantageously maintained. Similarly, when a workpiece manufactured in the step X (502) needs to be reprocessed and reloaded to the step X (502), a workpiece waiting to be loaded to the manufacturing path 1 may have to wait for a longer period, which contributes to reduction in productivity of the automated manufacturing system. However, if a device in the step XB (512) is idle, the procedure (521) in which a workpiece is transported from the step X (502) to the step XB (512) is used to transport the workpiece, which then undergoes reprocessing in the step XB. There is thus no waiting period described above, and hence the productivity is advantageously maintained.

What is claimed is:

1. A method for controlling workpiece transportation using a robot or an automated machine, the method applied to an automated manufacturing system, the method comprising:
monitoring the state of the automated manufacturing system to see if there is a request for transporting the workpiece;
extracting a subsequent step path for the workpiece when a transportation request is issued;
calculating a standard necessary period along the extracted step path;
converting the standard necessary period into an evaluation value and issuing a transportation request;
accumulating and stacking a plurality of transportation requests; and
selecting a workpiece with the shortest subsequent standard necessary period from the stacked transportation requests.

2. The transportation control method according to claim 1, further comprising:
reading an identification number displayed on a workpiece to be loaded in the automated manufacturing system; and
selecting a step path for the workpiece based on the read identification number,
wherein the selected step path for the workpiece is used to extract the subsequent step path.

3. The transportation control method according to claim 1, wherein extracting the subsequent step path comprises extracting a step path including a reprocessing step when it is necessary to perform reprocessing in which a step that has been completed in the automated manufacturing system is reprocessed.

4. The transportation control method according to claim 1, wherein extracting the subsequent step path comprises extracting a step path including the previous processing step when the workpiece is returned to the previous processing step in the automated manufacturing system.

5. The transportation control method according to claim 1, wherein calculating the standard necessary period comprises calculating the subsequent standard necessary period by considering variation in processing period in each step and, as the processing period, using not only the average processing period but also the shortest processing period, the longest processing period, and a period that differs from the average processing period by a certain amount.

6. The transportation control method according to claim 1, wherein calculating the standard necessary period is calculating the subsequent standard necessary period based on whether, in each step, the workpiece has been normally processed, requires to be reprocessed, or requires to be returned to the previous step.

7. A system for controlling workpiece transportation using a robot or an automated machine, the system applied to an automated manufacturing system, the system comprising:
a first storage unit that stores a step path for the workpiece;
a second storage unit that converts the subsequent standard necessary period along the step path for the workpiece into an evaluation value and stores a plurality of transportation requests;
state monitoring means for monitoring the state of the automated manufacturing system to see if there is a request for transporting the workpiece, in the event of an transportation request, extracting the subsequent step path for the workpiece that has issued the transportation request from the first storage unit, calculating the subsequent standard necessary period along the extracted step path, and converting the calculated subsequent standard necessary period into an evaluation value and storing the transportation request in the second storage unit; and
transportation control means for selecting a workpiece with the shortest subsequent standard necessary period from the transportation requests stored in the second storage unit.

8. The transportation control system according to claim 7, wherein when a workpiece is loaded in the automated manufacturing system, a step path for the workpiece is determined based on an identification number displayed on the workpiece, and the state monitoring means extracts the subsequent step path from the first storage unit based on the determined step path.

9. The transportation control system according to claim 7, wherein the state monitoring means extracts the subsequent step path including a reprocessing step from the first storage unit when it is necessary to perform reprocessing in which a step that has been completed in the automated manufacturing system is reprocessed.

10. The transportation control system according to claim 7, wherein the state monitoring means extracts the subsequent step path including the previous processing step when the workpiece is returned to the previous processing step in the automated manufacturing system.

11. The transportation control system according to claim 7, wherein the subsequent standard necessary period along the step path for the workpiece is calculated by considering variation in processing period in each step and, as the processing period, using not only the average processing period but also the shortest processing period, the longest processing period, and a period that differs from the average processing period by a certain amount.

12. The transportation control system according to claim 7, wherein the subsequent standard necessary period along the step path for the workpiece is calculated based on whether, in each step, the workpiece has been normally processed, requires to be reprocessed, or requires to be returned to the previous step.
